(19) United States
(12) Patent Application Publication
(10) Pub. No.: US 2020/0390251 A1
(43) Pub. Date: Dec. 17, 2020

(54) MINIATURE MEMORIAL DISPLAY DEVICE

(71) Applicant: Gary Jaworski-Sult, Pearce, AZ (US)

(72) Inventor: Gary Jaworski-Sult, Pearce, AZ (US)

(21) Appl. No.: 16/440,990

(22) Filed: Jun. 14, 2019

(51) Int. Cl. A47G 1/12; G09F 17/00; E04H 13/00

(52) U.S. Cl. CPC A47G 1/12; E04H 13/00; G09F 17/00

(57) ABSTRACT

A miniature memorial display device including a miniature housing member and a cover member. The housing member having a triangular shape and an interior triangular shaped cavity for receiving a memorial. The cover member is located within the cavity of the housing member immediately above the memorial for securing the memorial within the cavity.

### FIELD OF THE INVENTION

Embodiments described herein generally relate to a display device, and more particularly to a miniature memorial display device.

### BACKGROUND OF THE INVENTION

Flag cases are given to the family of deceased patriots during their funeral as a memoir. Although most loved ones would like to have a flag case for themselves as a remembrance, the flag cases are typically too bulky and expensive to reproduce for mass individuals. Hence, it is desirable to provide an efficient sized and less expensive display case for memorials.

### BRIEF DESCRIPTION OF THE DRAWINGS

The various advantages of the embodiments of the present disclosure will become apparent to one skilled in the art by reading the following specification and appended claims, and by referencing the following drawing(s), in which:

FIG. 1 shows an exemplary view of a miniature memorial display device according to an embodiment of the present disclosure.

### SUMMARY OF THE INVENTION

Exemplary embodiments disclosed herein describe a miniature memorial display device including a miniature housing member and a cover member. The housing member having a triangular shape and including an interior triangular shaped cavity for receiving a memorial. The cover member is located within the cavity of the housing member immediately above the memorial for securing the memorial within the cavity.

In some exemplary embodiments, the housing member is made of wood.

In some exemplary embodiments, the cover member is made of glass or plexiglass.

In some exemplary embodiments, the memorial is a casket flag.

In some exemplary embodiments, the miniature housing member has a width of seven inches, a length of three and one half inches and a depth of one and one half inches.

### DETAILED DESCRIPTION

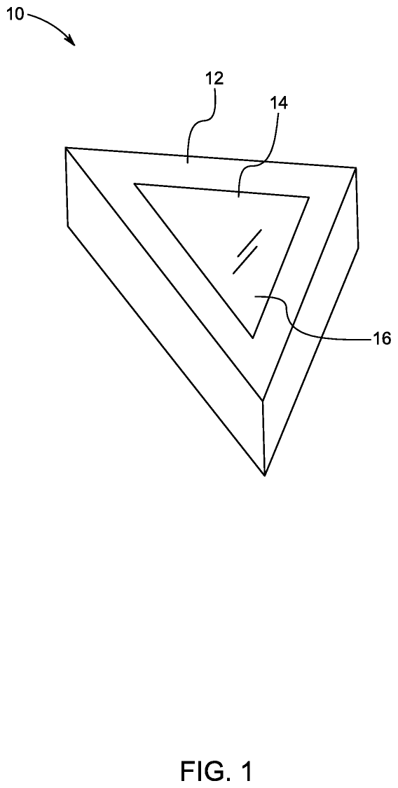

The present disclosure relates to a miniature memorial display device (“the device”). The device is uniquely designed to be a miniature size so that it is easier and less expensive to manufacture. As illustrated in FIG. 1, the device 10 includes a triangular shaped miniature housing member 12 and a cover member 16.

The housing member 12 is of a miniature size. In a preferred embodiment, the housing member is seven inches wide, three and one half inches long and has a depth of one and one half inches. The housing member may be made from any suitable material. In a preferred embodiment, the housing member is made of wood. The wood may be a stained wood. The housing member includes a triangular shaped interior cavity 14 for receiving a memorial. The memorial may be any suitable item that reminds an individual of a person or event. In a preferred embodiment, the memorial is a casket flag. The memorial is stored at a bottom layer of the housing member within the interior cavity 14.

The cover member 16 is located within the cavity 14 of the housing member 12 immediately above the memorial for securing the memorial within the cavity. The cover member is triangular shaped and may be made of any suitable material. The cover member is transparent so as to allow visibility of the memorial. In a preferred embodiment, the cover member is made of glass or plexiglass.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A miniature memorial display device comprising:
a triangular shaped miniature housing member having an interior triangular shaped cavity for receiving a memorial; and
a cover member located within the cavity of the housing member immediately above the memorial for securing the memorial within the cavity.

2. The device of claim 1, wherein the housing is made of wood.

3. The device of claim 1, wherein the cover member is made of glass or plexiglass.

4. The device of claim 1, wherein the memorial is a casket flag.

5. The device of claim 1, wherein the miniature housing member has a width of seven inches, a length of three and one half inches and a depth of one and one half inches.
